(19) United States
(12) Patent Application Publication
(10) Pub. No.: US 2017/0170648 A1
(43) Pub. Date: Jun. 15, 2017

(54) PROTECTIVE DEVICE FOR PROTECTING A TRANSFORMER AGAINST GEOMAGNETICALLY INDUCED CURRENTS

(71) Applicant: Siemens Aktiengesellschaft, Muenchen (DE)

(72) Inventor: Peter HAMBERGER, Kirchschlag bei Linz (AT)

(73) Assignee: SIEMENS AKTIENGESELLSCHAFT

(21) Appl. No.: 15/370,722

(22) Filed: Dec. 6, 2016

(30) Foreign Application Priority Data
Dec. 9, 2015 (EP) 15198574.4

(51) Int. Cl. H02H 7/04; H01F 27/28

(52) U.S. Cl. CPC H02H 7/04; H01F 27/28

(57) ABSTRACT

A protective device for a transformer which is connected on the high-voltage side via supply lines to a network for transmission and distribution of electrical energy, wherein the transformer includes a neutral grounding, where each supply line is connected to ground via a grounding transformer , and where the grounding transformer includes a neutral point resistance which is lower than the neutral point resistance of the neutral grounding, such that Geomagnetically Induced Current flowing on the supply lines is diverted to ground.

### BACKGROUND OF THE INVENTION

1. Field of the Invention

The invention relates generally to the technical field of electrical transformers and, more particularly, to a protective device for a transformer which is connected on the high-voltage side by via supply lines to a network for the transmission and distribution of electrical energy, where the transformer has a neutral grounding.

2. Description of the Related Art

It is well known that electrical transformers as routinely used in energy transmission and distribution networks can be exposed to Geomagnetically Induced Currents (GIC), which can exceed 100 A and cause serious faults in the operating characteristics of transformers.

A GIC is caused by strong solar winds that produce a temporal change in the Earth's magnetic field. If this temporal change in the Earth's magnetic field passes through a conductor loop (consisting of, e.g., a line section of the energy distribution network and the ground as a return conductor), a voltage of possibly several volts per kilometer of line length is induced in this conductor loop. This induced voltage causes the development of a low-frequency line current, i.e., the “GIC current”.

The “GIC current” is superimposed on the alternating current flowing in the conductors of the distribution network, causing a ripple current to develop. If this ripple current is then supplied via supply lines to a transformer or a substation, an asymmetrical modulation of the magnetic material in the transformer core is produced. Within the half wave in which the alternating flux and the unidirectional flux caused by GIC are superimposed on each other, the magnetically soft material of the transformer is driven into saturation. The transformer therefore acts like a choke with high reactive power absorption in this half wave. As a result, currents having high harmonics occur in the supply lines on the primary side of the transformer. The flux leakage field in the transformer therefore also has these harmonics. These higher frequency components in the flux leakage field result in increased eddy-current losses in the metallic parts of the transformer and changed current distribution in the windings of the transformer, which can cause unacceptably high heating locally. Increased heating adversely affects the service life of the electrical winding of the transformer, and cracked gases can occur due to thermal decomposition of the insulating fluid.

A further problem can arise if the high reactive power absorption also causes an unacceptably high voltage drop or if a protective device responds incorrectly due to the harmonics, and therefore GIC current flow can lead to a blackout in the energy distribution network in the worst case.

However, the GIC current flow also results in increased noise emission, this being particularly disadvantageous if the transformer is installed in the vicinity of a residential area.

In a time window that is relevant to the effect, GIC can be considered quasi as direct current. GIC is a natural event, and although the occurrence of a solar wind can be detected, its temporal characteristic in the network cannot be predicted in terms of magnitude and direction. It is possible for GIC to cause an interruption in a network for the supply and transmission of electrical energy.

In order to protect a transformer against GIC in an energy distribution network, use is routinely made of DC/GIC blockers. A GIC blocker essentially consists of a capacitor. The capacitor is connected between the neutral point and the ground connection of the transformer. In order to protect the capacitor against overcurrent or overvoltage, sophisticated protective devices are required at considerable expense. It is also disadvantageous that a GIC blocker can only protect the transformer between whose neutral point and ground it is connected. Other transformers may therefore be even more affected by GIC. A further disadvantage arises in the case of autotransformers, in that such GIC blockers cannot readily be used because there is no electrical isolation between primary and secondary sides.

Energy supply companies are making the claim that it is essential to manage GIC currents of up to 300 A in the neutral point, corresponding to a GIC current of 100 A per phase. Using existing protective devices, these high GIC currents can only be managed at significant expense.

A need therefore exists for a protective device by which one or more transformers in a network for the supply and transmission of electrical energy can be protected easily and reliably against even high GIC currents.

### SUMMARY OF THE INVENTION

It is therefore an object of the present invention to provide a protective device for a transformer, by which the transformer can be reliably protected against GIC in the simplest manner possible and over a long service life.

This and other objects and advantages are achieved by a protective device for a transformer which is connected on the high-voltage side by supply lines to a network for transmission and distribution of electrical energy, where the transformer has a neutral grounding.

The invention is based on the finding that in practice, in the case of a symmetrical network, GIC currents of temporally identical magnitude flow in the three phases of a three-phase transmission system, i.e., the GIC currents split into in symmetrical components cause only a low-frequency zero-sequence current which, in the time window of the effect, can be considered as direct current (also referred to below as DC portion).

Taking this as its starting point, the invention provides for this GIC current flowing in the supply line to a transformer or transformer station to be in large part diverted to ground before it can cause damage in the transformer.

In accordance with the invention, each supply line on the high-voltage side to a transformer is connected to ground via a grounding transformer, where the grounding transformer has a neutral point resistance (R0GIC) that is lower than the neutral point resistance (R0sub) of the neutral grounding of the transformer, such that a Geomagnetically Induced Current (GIC) flowing on the supply lines is diverted to ground.

The grounding transformer has a low zero-sequence resistance but a high positive-sequence and negative-sequence impedance. As a consequence, the DC portion, i.e., the GIC that is unwanted for the magnetic modulation does not arrive at the transformer, at least in its entirety, but is to a large extent diverted to ground before being input to the transformer. The damage in the transformer is therefore reduced: The asymmetrical modulation of the transformer core material is decreased. The eddy-current losses and hence the heating are reduced. A winding insulation exposed to less thermal stress is beneficial to a long service life of the transformer winding. The operating noise of the transformer is reduced. It is particularly advantageous in this case that the protective device is composed of purely passive components, which can be configured at comparatively little expense for even high GIC currents of more than 100 A and provide fault-free service for a long operating period. It is also advantageous to install this apparatus on the supply line to the transformer station, thereby protecting all electrical machines (transformers) installed downstream of it. From this is derived the economical advantage in particular.

In order to prevent as large a GIC portion as possible from reaching the transformer, an embodiment can be beneficial in which the value of the neutral point resistance (R0GIC) of the grounding transformer is one tenth or less of the value of the neutral point resistance (R0sub) of the transformer substation.

With regard to reliability and acceptance, in an advantageous embodiment the invention, the grounding transformer is configured as a three-phase transformer whose windings are zigzag connected. The protective device advantageously only has winding coils that are known from transformer construction.

In order to minimize the losses of the protective device, it can be beneficial to arrange a switching apparatus in each of the connection lines that respectively connect one of the three winding phases of the grounding transformer to corresponding lines of the three-phase network. This allows the protective device to be connected or disconnected from the network. It can then be deployed when GIC is actually observed or expected in the supply lines. Otherwise, the protective device remains in “standby” mode. Such a protective apparatus can be activated from this “standby” mode, alone or with others, at any time via a switching action in the network. The protective apparatus offers high availability. Switches suitable for the switching apparatus are commercially available. The protective device is only activated when required. As a result, the no-load losses are irrelevant in financial terms. It is therefore possible to use materials of lower quality that are more affordable.

In an inexpensive embodiment of the invention, the grounding transformer has a layered magnetic core of metal laminations and is made of conventional (not grain-oriented) electric sheet steel. The use of similar materials also increases the acceptance.

A further cost reduction can be achieved by using aluminum for the windings of the grounding transformer.

A particularly advantageous embodiment with respect to manufacturing costs takes the expected operating time of the protective apparatus into consideration. Barely any significant power losses occur in the protective apparatus and the anticipated operating time is comparatively shorter than the transformer to be protected. As a result, inexpensive materials can be used. The eddy-current losses are also irrelevant in financial terms as explained above. As a result, each winding can be made of an insulated aluminum flat conductor. The voltage class of the apparatus can be lower than that of the transformer to be protected.

The protective apparatus can advantageously be activated as required, where the switching apparatus is connected for signaling purposes to a global or regional detection and/or reporting device for Geomagnetically Induced Current (GIC). It is thereby possible to automatically protect a plurality of transformers in a rapid and reliable manner, where the transformers are arranged in a network for the transmission and distribution of energy.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In order to explain the invention further, reference is made in the following part of the description to drawings from which is it possible to derive further advantageous embodiments, details and developments of the invention on the basis of an exemplary embodiment which does not limit the scope of the invention, in which:

FIG. 1 shows as schematic block diagram of a protective device in accordance with a first embodiment;

FIG. 2 shows an equivalent connection diagram of the protective device of FIG. 1; and

FIG. 3 shows as schematic block diagram of a protective device in accordance with a second embodiment.

### DETAILED DESCRIPTION OF THE EXEMPLARY EMBODIMENTS

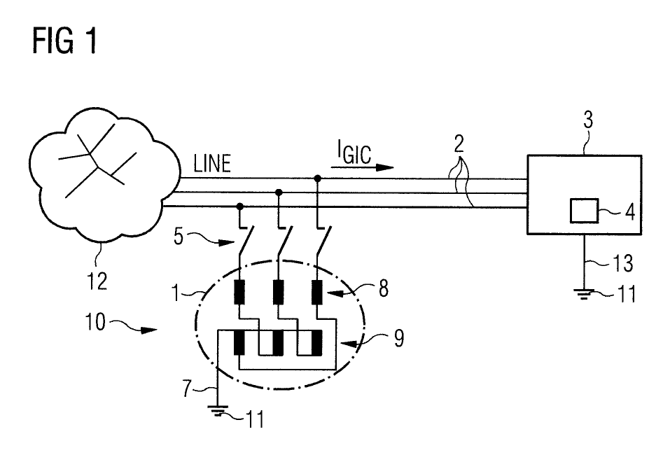

FIG. 1 shows a connection diagram of a first exemplary embodiment of the invention in a simplified illustration. The reference sign 10 designates the overall protective device. This consists essentially of a grounding transformer 1, which connects the three phases of the supply lines 2 (LINE) to a transformer 4 having ground potential 11. The transformer 4 is housed in a transformer substation 3.

In an energy supply network 12, the electrical energy is transformed from a high-voltage network (750-110 kV) to a medium-voltage network, or from a medium-voltage network (e.g., 10-30 kV) to a low-voltage network (secondary distribution network having a voltage of, e.g., 400 V/230 V), in a transformer substation 3, also known as a transformer station, distribution station or distribution substation. A transformer substation 3 contains at least one transformer with corresponding switching systems for the medium-voltage network and low-voltage network, and protective devices.

In this case, the protective device 10 in accordance with the invention is either arranged in the vicinity of a transformer substation 3 or situated in the transformer substation 3 itself.

A symmetrical network is assumed, in which GIC currents IGIC are equally distributed on all three conductors (LINE) of a three-phase system.

The exemplary embodiments illustrated also assume a low-impedance neutral grounding, where the grounding is either solid or via a resistance.

As stated in the introduction, it is an object of the present invention to protect the transformer 4 against the effects of a Geomagnetically Induced Current (GIC) that is induced in the network 12. A grounding transformer 1 is provided for this purpose.

The grounding transformer 1 is a three-phase transformer that is operated quasi with no load. It has a low zero-sequence resistance, but has a high positive-sequence and negative-sequence impedance. The grounding transformer 1 consists essentially of a magnetically soft core and a winding arrangement 8, 9 that is zigzag connected. The winding arrangement 8, 9 itself consists of three windings 8 on the supply line side and three windings 9 on the ground side. The windings 8, 9 are coupled together magnetically via a magnetically soft core, which is not shown in greater detail in FIG. 1. The magnetic core consists of metal laminations of electric sheet steel as used in transformer construction. Each of these windings 8, 9 forms a complex impedance, having an ohmic resistance portion and an inductive resistance portion.

The protective device 10 then functions in a manner whereby the windings 8, 9 of the grounding transformer 1 represent a high impedance in relation to three-phase current, but the ohmic resistance portion ROGIC, compared with the ohmic resistance ROsub of the neutral grounding 13 of the transformer 4 or the transformer substation, is comparatively low in relation to the GIC direct current. According to a preferred resistance ratio, the value of the neutral point resistance ROGIC of the grounding transformer 1 is one tenth or less of the value of the neutral point resistance ROsub of the transformer substation 3. This resistance ratio has the effect that the IGIC flowing on the supply lines 2 towards the transformer 4 chooses the low-impedance path and is in large part diverted to ground via the protective device 10. This diversion takes place upstream of the transformer. Only a comparatively small portion of the GIC arrives at the transformer 4 or the transformer substation 3. As a consequence, the disruptive GIC influence is at least moderated, if not in practical terms eliminated, for one or more transformers 4 arranged in the transformer substation 3.

In other words, the grounding transformer 1 provides an artificial neutral point. However, the grounding transformer 1 appears to have a low impedance in relation to the GIC direct current, i.e., the GIC only sees the ohmic portion of the complex impedance.

In order to achieve a low ohmic resistance of the grounding transformer 1, it has a small number of windings and a low current density. The grounding transformer 1 only operates with no load. As a result, the windings 8, 9 of the grounding transformer 1 need only be configured for the relatively low GIC currents (approximately 100 A).

It can be considered a significant advantage of the invention that the grounding transformer 1 functions in a purely passive manner and consists solely of passive components that are known from transformer construction. In its operating characteristics, the grounding transformer 1 behaves like a transformer that is operated with no load. The grounding transformer 1 can therefore remain connected to the energy supply network 12 at all times.

In order to further reduce losses of the protective apparatus 10, provision can be made to connect the grounding transformer 1 to the supply lines 2 of a high-voltage network quasi as required. The switching apparatus 5 is provided for this embodiment of the invention in FIGS. 1, 2 and 3. In this case, the protective device 10 is only temporarily in operation, i.e., only when GIC currents actually flow or are expected. As a result, the power loss in the magnetically soft core is uncritical, allowing the use of inexpensive materials. Grain-oriented electric sheet steel is not necessary, because iron losses are of lesser significance. Aluminum can be used for the winding 8 or 9. A flat conductor that is relatively inexpensive can be used for this economical embodiment. It is important only that the ohmic winding resistance must have a low value in comparison with the transformer 4 or transformer substation 3. In the presently contemplated exemplary embodiment, the ratio of the zero-sequence resistances is one to ten.

It is again noted, here, that the switching apparatus 5 is optional, i.e., the inventive effect is also achieved without this switching apparatus 5.

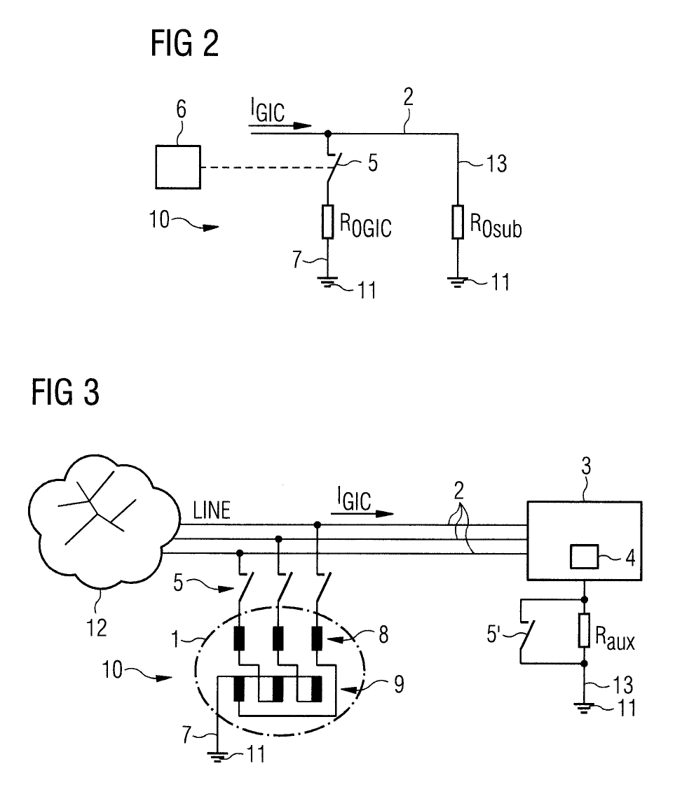

A criterion for switching into the network 12 of an energy supplier may be, e.g., a signal that is received from a (global) GIC detection and/or reporting device 6. This is illustrated schematically in FIG. 2.

FIG. 2 shows a simplified equivalent connection diagram, in which the inventive protective device 10 is shown as a parallel connection of an ohmic resistance (R0GIC: neutral point resistance of the grounding transformer) with an ohmic resistance of the transformer substation 3 (R0sub: neutral point resistance of the transformer substation). As mentioned in the introduction, the GIC induced in the lines of an energy supply system 12 by solar wind is a low-frequency ripple current, which can be considered as direct current in the observation period. The ohmic resistances R0GIC and ROsub are essentially critical in relation to this low-frequency GIC current IGIC. As a result, only the zero-sequence resistances of diversion device 1 and transformer or substation 2 are marked in this equivalent connection diagram shown in FIG. 2. The ohmic resistance of the grounding transformer 1 is lower than the ohmic resistance of the substation or the transformer 2. As stated above, a GIC that is flowing towards a transformer 1 on the supply line 2 is consequently diverted to ground according to the chosen resistance ratio R0GIC/R0sub before it can cause any damage in the transformer 4.

FIG. 3 shows a second embodiment of the invention, in which a modification is made to the operational grounding of a transformer substation 3 (substation or individual transformer 4), and the ohmic resistance between neutral point and ground is increased by providing an auxiliary resistance Raux. As a result of connecting this auxiliary resistance Raux between neutral point and ground for every transformer 4 in the substation 3, the neutral grounding 13 becomes highly resistive. As per the previous embodiment, the resistance ratio is again configured such that the disruptive GDC flows away to ground via the lower ohmic resistance of the diversion device 1 before it can cause damage in a transformer 4. The distribution of current is again indirectly proportionate to the ratio of the resistances in diversion device and transformer substation 3 or transformer 4.

In FIG. 3, a further switch 5′ is marked in parallel with the auxiliary resistance Raux and can be used to switch in the auxiliary resistance Raux if required, i.e., the switch 5′ is open if a GIC is flowing in the supply line 2. The switch 5′ is closed if no GIC is expected.

In summary, the essential advantage of the disclosed embodiments of the invention is that only components that work in a completely passive manner are used for GIC protection. The solution therefore contains no controlled components such as controlled valves with complex control switching.

It can be considered a further advantage that the operating costs can be kept very low. If the grounding transformer is only switched in as required, it can be manufactured very economically. This mode of operation allows the use of cheap magnetically soft materials. If an auxiliary resistance Raux is used in the neutral point of the transformer substation 3, it need only be configured for the zero-sequence current, which can be achieved at little expense. This auxiliary resistance Raux can be switched in to the ground current circuit as required by a switch 5′ that is connected in parallel.

A plurality of transformer substations each comprising one or more transformers 4 are usually provided at interfaces between medium voltage and low voltage in a network 12 for the distribution and transmission of electrical energy. The protective apparatus described above can be implemented in every supply line on the high-voltage side of a transformer station.

Although the invention is illustrated and described in detail with reference to the preferred exemplary embodiments presented above, the invention is not restricted by the examples disclosed herein, and other variations may be derived therefrom by a person skilled in the art without thereby departing from the scope of the invention.]

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A protective device for a transformer which is connected on the high-voltage side via supply lines to a network for transmission and distribution of electrical energy, the transformer including a neutral grounding, the protective device comprising:
a grounding transformer connecting each of the supply lines to ground, wherein the grounding transformer including:
a neutral point resistance which is lower than the neutral point resistance of the neutral grounding, such that Geomagnetically Induced Current (GIC) flowing on the supply lines is diverted to ground.

2. The protective device as claimed in claim 1, wherein a value of the neutral point resistance of the grounding transformer is one tenth or less of a value of the neutral point resistance of the neutral grounding.

3. The protective device as claimed in claim 1, wherein the grounding transformer is configured as a three-phase transformer having a winding arrangement which is formed by two three-phase windings and is zigzag connected.

4. The protective device as claimed in claim 3, wherein each winding phase of the three-phase windings is connected to an assigned line via a connection line.

5. The protective device as claimed in claim 4, further comprising:
a switching apparatus arranged in each connection line.

6. The protective device as claimed in claim 3, wherein the grounding transformer includes a layered magnetic core of metal laminations formed from conventional electric sheet steel.

7. The protective device as claimed in claim 3, wherein the material for the windings of the grounding transformer is aluminum.

8. The protective device as claimed in claim 7, wherein each winding of the windings is formed by an insulated flat conductor.

9. The protective device as claimed in claim 8, wherein insulation of the flat conductor has an insulation class which is lower than an insulation class of a primary or secondary winding of the transformer.

10. The protective device as claimed in claim 5, wherein the switching apparatus is connected for signaling purposes to at least one of (i) a detection for the GIC and (ii) a reporting device for the GIC.

11. The protective device as claimed in claim 1, wherein the protective device is implemented in the network for the transmission and distribution of the electrical energy.
